(19) United States
(12) Patent Application Publication
(10) Pub. No.: US 2021/0365131 A1
(43) Pub. Date: Nov. 25, 2021

(54) TOUCH DISPLAY DEVICE AND MANUFACTURING METHOD THEREOF

(71) Applicant: SHENZHEN CHINA STAR OPTOELECTRONICS SEMICONDUCTOR DISPLAY TECHNOLOGY CO., LTD., Shenzhen (CN)

(72) Inventors: Mingjun ZHOU, Shenzhen (CN); Zhenhua SHI, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/626,529

(22) PCT Filed: Dec. 5, 2019
(86) PCT No.: PCT/CN2019/123275

§ 371 Date: Dec. 25, 2019

(30) Foreign Application Priority Data
Oct. 12, 2019 (CN) 201910968162.7

(51) Int. Cl. G06F 3/041; B32B 37/12; B32B 37/10; B32B 37/00; B32B 37/14

(52) U.S. Cl. CPC G06F 3/041; B32B 37/12; B32B 37/1018; B32B 2457/208; B32B 37/144; G06F 2203/04103; B32B 37/003

(57) ABSTRACT

The present application discloses a touch display device and a manufacturing method thereof. In a process of bonding panels, a cover plate is attached to a touch panel to form a cover plate assembly by a liquid optically clear adhesive through a full lamination technique, and the cover plate assembly is attached to a display panel to form a vacuum chamber by a solid optically clear adhesive through an edge lamination technique. In the formed touch display device, the cover plate, the touch panel, and the display panel are bonded tightly. Therefore, the optically clear adhesives are saved, production cost is reduced, and product yield is improved.

### CROSS-REFERENCE TO RELATED APPLICATIONS

This application claims the priority to Chinese Patent Application No. 201910968162.7, entitled “TOUCH DISPLAY DEVICE AND MANUFACTURING METHOD THEREOF” and filed on Oct. 12, 2019 with the State Intellectual Property Office of the People's Republic of China, which is entirely incorporated by reference into the present application.

### FIELD OF APPLICATION

The present application is related to the field of display technology, and specifically to a touch display device and a manufacturing method thereof.

### BACKGROUND OF APPLICATION

With continuous development of science and technology, more and more electronic devices with touch functions are widely used in people's daily lives and work, which brings great convenience to people's daily lives and work. Touch technology is an important link in a process of human-computer interaction. Display devices, such as smartphones and tablets, require touch technology support.

A touch panel, known as a touch screen, is a device formed on a display surface of an image display device and uses a conductor, such as a human body or a capacitive pen, for command input. External input devices such as mice, keyboards, and mechanical input buttons can be replaced by touch panels that effectively simplify structures of electronic products such as computers, mobile phones, electronic meters, and gaming devices, and have very broad application prospects. Classified by technical principles, the touch panels are mainly a capacitive type, a resistive type, an ultrasonic type, and an infrared type.

Infrared touch technology currently occupies a large part of touch market with its advantages of accurate touch accuracy and relatively low cost. However, the infrared touch technology is not suitable for places with strong light. When sunlight directly irradiates on a touch surface, and obstructions such as dust and water droplets is on the touch surface, the touch accuracy will be affected. With a gradual reduction of the cost and increasing size of capacitors, capacitive touch technology has been used and praised by more and more users for its advantages such as high sensitivity, strong anti-interference ability, wide application scenarios, and small impact on appearance of the machine.

### SUMMARY OF APPLICATION

Please refer to FIG. 1, which is a structural diagram of a touch display device in the prior art, the touch display device includes a cover glass 11, a touch panel 13, and a display panel 15. Neighboring components are bonded by a liquid optically clear adhesive (SOCA) 19 through a full lamination technique.

In the field of commercial display, large display devices such as educational whiteboards and high-end conference machines need large-sized touch display devices to facilitate operation and presentation. For the large-size touch display devices, the full lamination technique needs a large amount of the SOCA, which greatly increases production cost and exists a defect of degumming. Also, because the neighboring components are bonded by the SOCA through the full lamination technique, there will be problems of yellowing, different bending, and wrinkles in a visible region.

The purpose of the present application is to provide a touch display device and a manufacturing method thereof in accordance with problems in the prior art. A small amount of optically clear adhesive can be used in a vacuum bonding method to make a cover plate, a touch panel, and a display panel bond tightly, saving the optically clear adhesive and improving product yield.

In order to achieve the above purpose, the present application provides a manufacturing method of a touch display device, including the steps of: providing a touch panel; covering an upper surface of the touch panel with a full adhesive layer, wherein the full adhesive layer is a liquid optically clear adhesive; disposing a cover plate on an upper surface of the touch panel, wherein the cover plate is disposed opposite to a middle portion of the touch panel, a lower surface of the cover plate is attached to the upper surface of the touch panel, and a cover plate assembly is formed; attaching a first sub-sealant layer to an edge of a lower surface of the touch panel, wherein the first sub-sealant layer is a liquid adhesive; cutting a solid optically clear adhesive into a strip-shaped adhesive block to attach to a lower surface of the first sub-sealant layer, wherein a width of the strip-shaped adhesive block is less than a width of the first sub-sealant layer; disposing the cover plate assembly on an upper surface of a display panel, wherein the display panel is disposed opposite to a middle portion of the cover plate assembly, and a lower surface of the strip-shaped adhesive block is attached to the upper surface of a display panel; sending the cover plate assembly and the display panel into a vacuum device, evacuating the vacuum device by a vacuum pump in a sealed environment, and heating the cover plate assembly and the display panel by a heating module in the vacuum device to melt the strip-shaped adhesive block; and curing the full adhesive layer by irradiating the cover plate assembly and the display panel with ultraviolet light in a vacuum environment, curing the strip-shaped adhesive block to form a second sub-sealant layer, and forming a vacuum chamber in a middle portion between the first sub-sealant layer and the second sub-sealant layer.

In order to achieve the above purpose, the present application provides a touch display device, including: a touch panel; a full adhesive layer attached to an upper surface of the touch panel; a cover plate attached to an upper surface of the full adhesive layer, wherein the cover plate is disposed opposite to a middle portion of the touch panel; a sealant layer attached to an edge of a lower surface of the touch panel; a vacuum chamber formed in a middle portion of the sealant layer; and a display panel attached to a lower surface of the sealant layer, wherein the display panel is disposed opposite to the middle portion of the touch panel.

In order to achieve the above purpose, the present application provides a manufacturing method of a touch display device, including the steps of: providing a touch panel; covering an upper surface of the touch panel with a full adhesive layer; disposing a cover plate on an upper surface of the touch panel, wherein the cover plate is disposed opposite to a middle portion of the touch panel, a lower surface of the cover plate is attached to the upper surface of the touch panel, and a cover plate assembly is formed; attaching a sealant layer to an edge of a lower surface of the touch panel; disposing the cover plate assembly on an upper surface of a display panel, wherein the display panel is disposed opposite to a middle portion of the cover plate assembly, and a lower surface of the sealant layer is attached to the upper surface of a display panel; and curing the full adhesive layer and the sealant layer by irradiating the cover plate assembly and the display panel with ultraviolet light in a vacuum environment, and forming a vacuum chamber in a middle portion of the sealant layer.

In a process of bonding panels of the present application, the cover plate is attached to the touch panel to form the cover plate assembly by the liquid optically clear adhesive through the full lamination technique, and the cover plate assembly is attached to the display panel to form the vacuum chamber by the solid optically clear adhesive through an edge lamination technique. In the formed touch display device, the cover plate, the touch panel, and the display panel are bonded tightly. Therefore, a surface of a touch region has better flatness, a sensitivity of a touch operation is higher, a touch experience is better, the optically clear adhesive is saved, production cost is reduced, problems of yellowing, different bending, and wrinkles in a visible region are avoided, and product yield is improved.

### DESCRIPTION OF DRAWINGS

In order to describe technical solutions in the present application clearly, drawings to be used in the description of embodiments will be described briefly below. Obviously, drawings described below are only for some embodiments of the present application, and other drawings may be obtained by those skilled in the art based on these drawings without creative efforts.

FIG. 1 is a structural diagram of a touch display device in the prior art.

FIG. 2 is a structural diagram of a touch display device of one embodiment of the present application.

FIG. 3 is a structural diagram of a touch display device of another embodiment of the present application.

FIG. 4 is a flowchart of a manufacturing method of the touch display device of the present application.

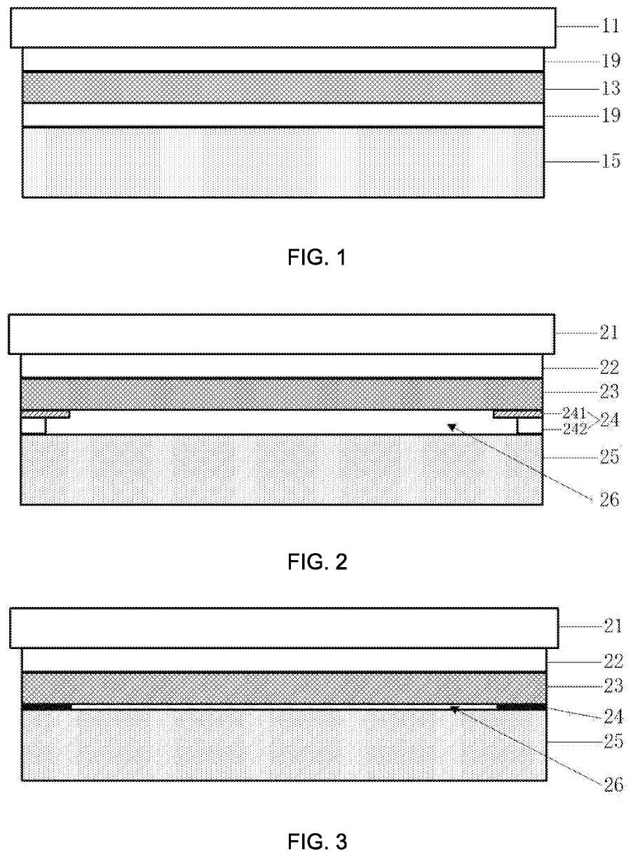

### DETAILED DESCRIPTION OF PREFERRED EMBODIMENTS

Embodiments of the present application are described detailly below. Examples of the embodiments are shown in the drawings, and units of the same or similar functions are using the same or similar numeral to represent. Embodiments reference to the appended drawings are used to describe and understand the present application, not to limit the present application.

It should be noted that, herein, relational terms such as first, second, third and the like are only used to distinguish one entity or operation from another entity or operation. It is not required or implied that these entities or operations exist any such relationship or order between them. Moreover, the terms “include,” include,” or any other variation thereof, are intended to cover a non-exclusive inclusion.

In the present application, unless otherwise specifically stated and defined, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Various embodiments or examples are provided here below to implement the different structures of the present application. To simplify the disclosure of the present application, description of the components and arrangements of specific examples is given below. Of course, they are only illustrative and not limiting the present application. Moreover, in the present application, reference numbers and/or letters may be repeated in different embodiments. Such repetition is for the purposes of simplification and clearness, and does not denote the relationship between respective embodiments and/or arrangements being discussed. Furthermore, the present application provides various examples for specific process and materials. However, it is obvious for a person of ordinary skill in the art that other processes and/or materials may alternatively be utilized.

Referring to FIG. 2, which is a structural diagram of a touch display device of one embodiment of the present application, the touch display device in the present application includes: a cover plate 21, a touch panel 23, a display panel 25. The cover plate 21 is attached to the touch panel 23 by a full adhesive layer 22. The touch panel 23 is attached to the display panel 25 by a sealant layer 24. A vacuum chamber 26 is formed between the touch panel 23 and the display panel 25.

The cover plate 21 is used to protect the touch panel 23 and the display panel 25, and a user can directly perform a touch operation on the cover plate 21. Preferably, a surface area of the cover plate 21 is larger than a surface area of the touch panel 23, so that the cover plate 21 can completely cover the touch panel 23. Therefore, the touch operation performed by the user on the cover plate 21 has a good sensitivity and is conducive to achieving a narrow frame design. The cover plate 21 can be a glass cover plate.

The touch panel 23 is attached to a lower surface of the cover plate 21 and disposed opposite to a middle portion of the cover plate 21, so that the cover plate 21 can completely cover the touch panel 23. Therefore, the user can directly perform the touch operation on the cover plate 21, and the touch operation has a good sensitivity.

The full adhesive layer 22 is attached to an upper surface of the touch panel 23, and the lower surface of the cover plate 21 is attached to an upper surface of the full adhesive layer 22, so that the cover plate 21 is attached to the touch panel 23.

Furthermore, the full adhesive layer 22 is a liquid optically clear adhesive (LOCA). The LOCA is a special adhesive used for bonding of transparent optical elements, and is colorless and transparent with a light transmittance of more than 98%, which can ensure accurate colors and sufficient display brightness. The LOCA has a good bonding strength, can be cured at normal or medium temperature, and has characteristics of low curing shrinkage and yellowing resistance. Because the full adhesive layer 22 is the LOCA and completely covers the upper surface of the touch panel 23, the cover plate 21 is attached to the touch panel 23 by the LOCA through a full lamination technique to form a cover plate assembly 20. The cover plate assembly 23 formed by the full lamination technique has better surface flatness in the touch region, a higher sensitivity of the touch operation, and a better touch experience.

The display panel 25 is attached to a lower surface of the touch panel 23 and disposed opposite to a middle portion of the touch panel 23, which ensures an operable region of the touch panel 23 consistent with a display region of the display panel 25. The display panel 25 can be a liquid crystal display (LCD) panel, an organic light-emitting diode (OLED) display panel, an active-matrix organic light-emitting diode (AMOLED) display panel, a quantum-dot light-emitting diode (QLED) display panel. The display panel 25 is used to provide display images for the touch display device.

Furthermore, a shape and a size of the touch panel are same as a shape and a size of the display panel, which further effectively ensures the operable region of the touch panel 23 consistent with a display region of the display panel 25.

The sealant layer 24 is attached to an edge of the lower surface of the touch panel 23, and the display panel 25 is attached to a lower surface of the sealant layer 24, so that the display panel 25 is attached to the touch panel 23. The vacuum chamber 26 is formed in a middle portion of the sealant layer 24. Because the middle portion of the touch panel 23 and a middle portion of the display panel 25 form a vacuum and are attached to each other under the effect of atmospheric pressure, a space occupied by the vacuum chamber 26 is compressed to a minimum, and the display panel 25 and the touch panel 23 can be bonded tightly. Therefore, the operation performed by the user on the cover plate 21 covering the touch panel 23 has good sensitivity.

Furthermore, the sealant layer 24 is a solid optically clear adhesive (SOCA). The SOCA can be melted by heating and be cured by irradiating of ultraviolet light. Because the sealant layer 24 is the SOCA and is attached to the edge of the lower surface of the touch panel 23, the display panel 25 is attached to the touch panel 23 by the SOCA through an edge lamination technique. Because the full lamination technique needs a large amount of optically clear adhesive, production cost of the panels is greatly increased, the edge lamination technique is used between the display panel 25 and the touch panel 23 to effectively save the optically clear adhesive.

Furthermore, the sealant layer 24 includes: a first sub-sealant layer 241 and a second sub-sealant layer 242. The first sub-sealant layer 241 is attached to the edge of the lower surface of the touch panel 23. The second sub-sealant layer 242 is attached to a lower surface of the first sub-sealant layer 241. The display panel 25 is attached to a lower surface of the second sub-sealant layer 242, so that the display panel 25 is attached to the touch panel 23. The vacuum chamber 26 is formed in a middle portion between the first sub-sealant layer 241 and the second sub-sealant layer 242.

Furthermore, the first sub-sealant layer 241 is an adhesive with high adhesion, which can pre-fix and position the second sub-sealant layer 242 to prevent the second sub-sealant layer 242 from being distorted. The first sub-sealant layer 241 can be the LOCA or the SOCA, as long as the second sub-sealant layer 242 can be attached to the first sub-sealant layer 241 tightly, so that the second sub-sealant layer 242 can consistent with the first sub-sealant layer 241. The second sub-sealant layer 242 is the SOCA. A width of the second sub-sealant layer 242 is less than or equal to the width of the first sub-sealant layer 241, so that the second sub-sealant layer 242 can be attached to the lower surface of the first sub-sealant layer 241, which prevents the second sub-sealant layer 242 from being distorted or peeled off. FIG. 2 is used to illustrate positional relationships of components. Actually, the middle portion of the display panel 25 and the middle portion of the touch panel 23 are attached to each other under the effect of atmospheric pressure, and the space occupied by the vacuum chamber 26 is compressed to a minimum, which ensures a sensitivity of the touch operation.

An uncured optically clear adhesive has extremely low adhesion, especially when implementing a design of the touch display device with a narrow frame. If the optically clear adhesive is directly attached to the lower surface of the touch panel 23, the optically clear adhesive is easily distorted. During the curing process of the optically clear adhesive, the display panel 25 and the touch panel 23 cannot be bonded tightly, thereby affecting a quality of the touch display device. A cured optically clear adhesive has an excellent weather resistance, especially excellent anti-spread and anti-explosive properties, which greatly improves safety, reliability, durability, and aesthetics of the display field. It has high transmittance, high bonding strength, low haze, low shrinkage, yellowing resistance, etc., and are mainly suitable for the field of full lamination such as medium and large-sized computers, LCDs, and all-in-ones. Therefore, the first sub-sealant layer 241 with high adhesion is pre-attached to the lower surface of the touch panel 23 to prevent the second sub-sealant layer 242 with a narrow SOCA from being distorted or peeled off during alignment and attachment, which avoids potential safety problems and inaccurate alignment problems.

Furthermore, a shape of the second sub-sealant layer 242 is a ring shape, so that the display panel 25 and the touch panel 23 can be bonded tightly by the full lamination technique. Because the shape of the second sub-sealant layer 242 is the ring shape, a shape of the first sub-sealant layer 241 is preferably a ring shape. The shapes of the first sub-sealant layer 241 and the second sub-sealant layer 242 are consistent to let the display panel 25 and the touch panel 23 bond tightly during vacuum attachment, and prevent the second sub-sealant layer 242 from being distorted or peeled off during the vacuum attachment.

In a process of bonding panels of the touch display device provided by the present application, the cover plate is attached to the touch panel to form the cover plate assembly by the liquid optically clear adhesive through the full lamination technique, and the cover plate assembly is attached to the display panel to form the vacuum chamber by the solid optically clear adhesive through an edge lamination technique. In the formed touch display device, the cover plate, the touch panel, and the display panel are bonded tightly. Therefore, a surface of a touch region has better flatness, a sensitivity of a touch operation is higher, a touch experience is better, the optically clear adhesive is saved, production cost is reduced, problems of yellowing, different bending, and wrinkles in a visible region are avoided, and product yield is improved.

Referring to FIG. 3, which is a structural diagram of a touch display device of another embodiment of the present application, a difference from the embodiment shown in FIG. 2 is that this embodiment uses heating and irradiating of ultraviolet light to melt and cure adhesives. After the sealant layer 24 is melted and leveled, the middle portion of the display panel 25 and the middle portion of the touch panel 23 are attached to each other under the effect of atmospheric pressure, and the space occupied by the vacuum chamber 26 is compressed to a minimum, which ensures a sensitivity of the touch operation.

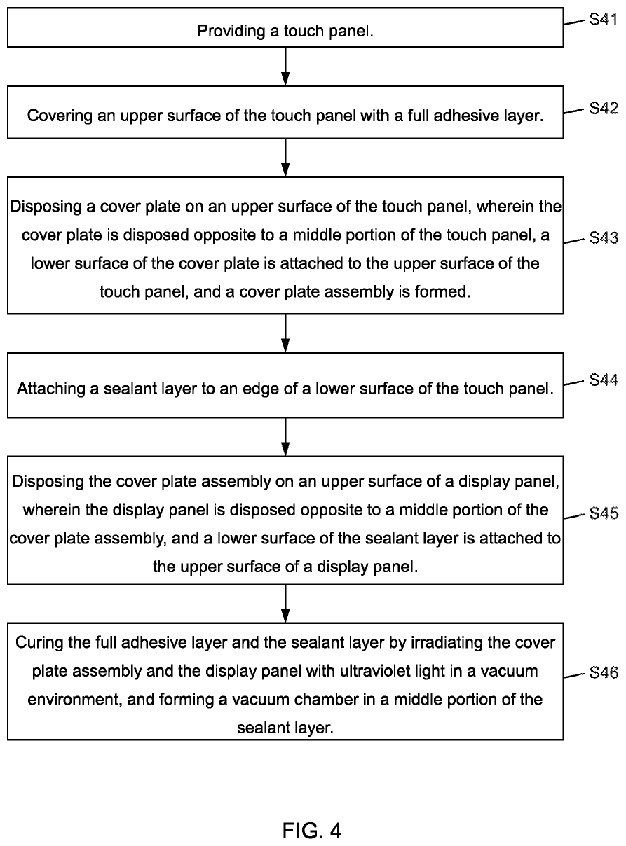

Referring to FIG. 4, which is a flowchart of a manufacturing method of the touch display device of the present application, the manufacturing method includes the steps of:

S41: providing a touch panel.

S42: covering an upper surface of the touch panel with a full adhesive layer.

S43: disposing a cover plate on an upper surface of the touch panel, wherein the cover plate is disposed opposite to a middle portion of the touch panel, a lower surface of the cover plate is attached to the upper surface of the touch panel, and a cover plate assembly is formed.

A charge-coupled device (CCD) alignment or an assisted positioning tool can be adopted, so that the cover plate 21 is disposed opposite to the middle portion of the touch panel 23. Preferably, a surface area of the cover plate 21 is larger than a surface area of the touch panel 23, so that the cover plate 21 can completely cover the touch panel 23. Therefore, the touch operation performed by the user on the cover plate 21 has a good sensitivity and is conducive to achieving a narrow frame design. The cover plate 21 can be a glass cover plate.

Furthermore, the full adhesive layer 22 is a liquid optically clear adhesive (LOCA). Because the full adhesive layer 22 is the LOCA and completely covers the upper surface of the touch panel 23, the cover plate 21 is attached to the touch panel 23 by the LOCA through a full lamination technique to form a cover plate assembly 20. The cover plate assembly 23 formed by the full lamination technique has better surface flatness in the touch region, a higher sensitivity of the touch operation, and a better touch experience.

S44: attaching a sealant layer to an edge of a lower surface of the touch panel.

S45: disposing the cover plate assembly on an upper surface of a display panel, wherein the display panel is disposed opposite to a middle portion of the cover plate assembly, and a lower surface of the strip-shaped adhesive block is attached to the upper surface of a display panel. The display panel 25 is used to provide display images for the touch display device. The CCD alignment or the assisted positioning tool can be adopted, so that the display panel 23 is disposed opposite to a middle portion of the cover plate assembly 20. Furthermore, a shape and a size of the touch panel are same as a shape and a size of the display panel, which further effectively ensures the operable region of the touch panel 23 consistent with a display region of the display panel 25.

Furthermore, the sealant layer 24 is a solid optically clear adhesive (SOCA). The SOCA can be melted by heating and be cured by irradiating of ultraviolet light. Because the sealant layer 24 is the SOCA and is attached to the edge of the lower surface of the touch panel 23, the display panel 25 is attached to the touch panel 23 by the SOCA through an edge lamination technique. Because the full lamination technique needs a large amount of optically clear adhesive, production cost of the panels is greatly increased, the edge lamination technique is used between the display panel 25 and the touch panel 23 to effectively save the optically clear adhesive.

S46: curing the full adhesive layer and the sealant layer by irradiating the cover plate assembly and the display panel with ultraviolet light in a vacuum environment, and forming a vacuum chamber in a middle portion of the sealant layer. The prepared touch display panel is as shown in FIG. 3.

The cover plate assembly 20 and the display panel 25 is sent into a vacuum device, the vacuum device is evacuated by a vacuum pump in a sealed environment, and the cover plate assembly 20 and the display panel 25 is heating by a heating module (e.g. a heating tube provided) in the vacuum device to melt the sealant layer 24 made of the SOCA. The sealant layer 24 is melted and leveled under dual effects of heating and pressure, so that an edge of the touch panel 23 and an edge of the display panel 25 are bonded tightly. A middle portion between the touch panel 23 and the display panel 25 is a vacuum region surrounded by the sealant layer 24, and the touch panel 23 and the display panel 25 are bonded tightly under the effect of atmospheric pressure, which ensures a sensitivity of the touch operation.

Furthermore, the step S44 further includes the steps of: 41) attaching a first sub-sealant layer to the edge of the lower surface of the touch panel; and 42) cutting a solid optically clear adhesive into a strip-shaped adhesive block to attach to a lower surface of the first sub-sealant layer, wherein a width of the strip-shaped adhesive block is less than a width of the first sub-sealant layer. Correspondingly, the step S45 further includes the steps of: 51) heating the cover plate assembly and the display panel in the vacuum environment to melt the strip-shaped adhesive block; and 52) curing the full adhesive layer by irradiating the cover plate assembly and the display panel with ultraviolet light in a vacuum environment, curing the strip-shaped adhesive block to form a second sub-sealant layer, and forming a vacuum chamber in in a middle portion between the first sub-sealant layer and the second sub-sealant layer.

Furthermore, the first sub-sealant layer 241 is an adhesive with high adhesion, which can pre-fix and position the second sub-sealant layer 242 to prevent the second sub-sealant layer 242 from being distorted. The first sub-sealant layer 241 can be the LOCA or the SOCA, as long as the second sub-sealant layer 242 can be attached to the first sub-sealant layer 241 tightly, so that the second sub-sealant layer 242 can consistent with the first sub-sealant layer 241. Preferably, the first sub-sealant layer 241 is connected end to end to prepare for subsequent processes, but is not limited thereto, and those skilled in the art can set it according to actual requirements.

Furthermore, the second sub-sealant layer 242 is the SOCA. A width of the second sub-sealant layer 242 is less than or equal to the width of the first sub-sealant layer 241, so that the second sub-sealant layer 242 can be attached to the lower surface of the first sub-sealant layer 241, which prevents the second sub-sealant layer 242 from being distorted or peeled off. The step 42) further includes the steps of: cutting the solid optically clear adhesive into four strip-shaped adhesive blocks; connecting the four strip-shaped adhesive blocks end to end to preferably form a ring shape, but is not limited thereto; and attaching the four strip-shaped adhesive blocks to the lower surface of the first sub-sealant layer. The SOCA can be cut into narrow strip-shaped adhesive blocks by die cutting or laser cutting to achieve the narrow frame design.

Because the shape of the second sub-sealant layer 242 is the ring shape, a shape of the first sub-sealant layer 241 is preferably a ring shape. The shapes of the first sub-sealant layer 241 and the second sub-sealant layer 242 are consistent to let the display panel 25 and the touch panel 23 bond tightly during vacuum attachment, and prevent the second sub-sealant layer 242 from being distorted or peeled off during the vacuum attachment.

Furthermore, the step 51) further includes: sending the cover plate assembly and the display panel into a vacuum device; evacuating the vacuum device by a vacuum pump in a sealed environment; and heating the cover plate assembly and the display panel by a heating module in the vacuum device to melt the strip-shaped adhesive block. In the vacuum environment, the strip-shaped adhesive block will melt when heated to 60° C. to 80° C. The strip-shaped adhesive block is melted and leveled under dual effects of heating and pressure, and is mixed with the first sub-sealant layer 241, so that the edge of the touch panel 23 and the edge of the display panel 25 are bonded tightly. In this embodiment, the strip-shaped adhesive block is melted to form a rectangular ring, a middle of the rectangular ring is the vacuum region surrounded by the first sub-sealant layer 241 and the melted leveled second sub-sealant layer 242, and the touch panel 23 and the display panel 25 are bonded tightly under the effect of atmospheric pressure, which ensures a sensitivity of the touch operation.

In a process of bonding panels of the touch display device provided by the present application, the cover plate is attached to the touch panel to form the cover plate assembly by the liquid optically clear adhesive through the full lamination technique, and the cover plate assembly is attached to the display panel to form the vacuum chamber by the solid optically clear adhesive through an edge lamination technique. In the formed touch display device, the cover plate, the touch panel, and the display panel are bonded tightly. Therefore, a surface of a touch region has better flatness, a sensitivity of a touch operation is higher, a touch experience is better, the optically clear adhesive is saved, production cost is reduced, problems of yellowing, different bending, and wrinkles in a visible region are avoided, and product yield is improved.

Understandably, those having ordinary skills of the art may easily contemplate various changes and modifications of the technical solution and technical ideas of the present application and all these changes and modifications are considered within the protection scope of right for the present application.

What is claimed is:

1. A manufacturing method of a touch display device, comprising the steps of:
providing a touch panel;
covering an upper surface of the touch panel with a full adhesive layer, wherein the full adhesive layer is a liquid optically clear adhesive;
disposing a cover plate on an upper surface of the touch panel, wherein the cover plate is disposed opposite to a middle portion of the touch panel, a lower surface of the cover plate is attached to the upper surface of the touch panel, and a cover plate assembly is formed;
attaching a first sub-sealant layer to an edge of a lower surface of the touch panel, wherein the first sub-sealant layer is a liquid adhesive;
cutting a solid optically clear adhesive into a strip-shaped adhesive block to attach to a lower surface of the first sub-sealant layer, wherein a width of the strip-shaped adhesive block is less than a width of the first sub-sealant layer;
disposing the cover plate assembly on an upper surface of a display panel, wherein the display panel is disposed opposite to a middle portion of the cover plate assembly, and a lower surface of the strip-shaped adhesive block is attached to the upper surface of a display panel;
sending the cover plate assembly and the display panel into a vacuum device, evacuating the vacuum device by a vacuum pump in a sealed environment, and heating the cover plate assembly and the display panel by a heating module in the vacuum device to melt the strip-shaped adhesive block; and
curing the full adhesive layer by irradiating the cover plate assembly and the display panel with ultraviolet light in a vacuum environment, curing the strip-shaped adhesive block to form a second sub-sealant layer, and forming a vacuum chamber in a middle portion between the first sub-sealant layer and the second sub-sealant layer.

2. The manufacturing method as claimed in claim 1, wherein the cover plate is attached to the touch panel by the liquid optically clear adhesive through a full lamination technique.

3. The manufacturing method as claimed in claim 1, wherein the step of cutting the solid optically clear adhesive into the strip-shaped adhesive block to attach to the lower surface of the first sub-sealant layer further comprises the steps of:
cutting the solid optically clear adhesive into four strip-shaped adhesive blocks;
connecting the four strip-shaped adhesive blocks end to end to form a ring shape; and
attaching the four strip-shaped adhesive blocks to the lower surface of the first sub-sealant layer.

4. The manufacturing method as claimed in claim 1, wherein a width of the second sub-sealant layer is less than or equal to the width of the first sub-sealant layer.

5. The manufacturing method as claimed in claim 1, wherein a shape of the touch panel is same as a shape of the display panel; and
a size of the touch panel is same as a size of the display panel.

6. A touch display device, comprising:
a touch panel;
a full adhesive layer attached to an upper surface of the touch panel;
a cover plate attached to an upper surface of the full adhesive layer, wherein the cover plate is disposed opposite to a middle portion of the touch panel;
a sealant layer attached to an edge of a lower surface of the touch panel;
a vacuum chamber formed in a middle portion of the sealant layer; and
a display panel attached to a lower surface of the sealant layer, wherein the display panel is disposed opposite to the middle portion of the touch panel.

7. The touch display device as claimed in claim 6, wherein the full adhesive layer is a liquid adhesive, and the cover plate is attached to the touch panel to form a cover plate assembly by the liquid optically clear adhesive through a full lamination technique; and
the sealant layer is a solid optically clear adhesive, and the cover plate assembly is attached to the display panel by the solid optically clear adhesive through an edge lamination technique.

8. The touch display device as claimed in claim 6, wherein the sealant layer comprises:
a first sub-sealant layer attached to the edge of the lower surface of the touch panel; and
a second sub-sealant layer attached to a lower surface of the first sub-sealant layer;
wherein the vacuum chamber is formed in a middle portion between the first sub-sealant layer and the second sub-sealant layer.

9. The touch display device as claimed in claim 8, wherein the first sub-sealant layer is a liquid adhesive or a solid adhesive; and
the second sub-sealant layer is the solid optically clear adhesive, and a width of the second sub-sealant layer is less than or equal to the width of the first sub-sealant layer.

10. The touch display device as claimed in claim 8, wherein a shape of the second sub-sealant layer is a ring shape.

11. The touch display device as claimed in claim 6, wherein a shape of the touch panel is same as a shape of the display panel; and
a size of the touch panel is same as a size of the display panel.

12. A manufacturing method of a touch display device, comprising the steps of:
providing a touch panel;
covering an upper surface of the touch panel with a full adhesive layer;
disposing a cover plate on an upper surface of the touch panel, wherein the cover plate is disposed opposite to a middle portion of the touch panel, a lower surface of the cover plate is attached to the upper surface of the touch panel, and a cover plate assembly is formed;
attaching a sealant layer to an edge of a lower surface of the touch panel;
disposing the cover plate assembly on an upper surface of a display panel, wherein the display panel is disposed opposite to a middle portion of the cover plate assembly, and a lower surface of the sealant layer is attached to the upper surface of a display panel; and
curing the full adhesive layer and the sealant layer by irradiating the cover plate assembly and the display panel with ultraviolet light in a vacuum environment, and forming a vacuum chamber in a middle portion of the sealant layer.

13. The manufacturing method as claimed in claim 12, wherein the full adhesive layer is a liquid optically clear adhesive, and the cover plate is attached to the touch panel by the liquid optically clear adhesive through a full lamination technique.

14. The manufacturing method as claimed in claim 12, wherein the sealant is a solid optically clear adhesive, and the cover plate assembly is attached to the display panel by the solid optically clear adhesive through an edge lamination technique.

15. The manufacturing method as claimed in claim 12, wherein the step of attaching a sealant layer to an edge of a lower surface of the touch panel further comprises the steps of:
attaching a first sub-sealant layer to the edge of the lower surface of the touch panel; and
cutting a solid optically clear adhesive into a strip-shaped adhesive block to attach to a lower surface of the first sub-sealant layer, wherein a width of the strip-shaped adhesive block is less than a width of the first sub-sealant layer;
wherein the step of curing the full adhesive layer and the sealant layer by irradiating the cover plate assembly and the display panel with ultraviolet light in a vacuum environment, and forming a vacuum chamber in a middle portion of the sealant layer further comprises the steps of:
heating the cover plate assembly and the display panel in the vacuum environment to melt the strip-shaped adhesive block; and
curing the full adhesive layer by irradiating the cover plate assembly and the display panel with ultraviolet light in a vacuum environment, curing the strip-shaped adhesive block to form a second sub-sealant layer, and forming a vacuum chamber in in a middle portion between the first sub-sealant layer and the second sub-sealant layer.

16. The manufacturing method as claimed in claim 15, wherein the first sub-sealant layer is a liquid adhesive or a solid adhesive; and
a width of the second sub-sealant layer is less than or equal to the width of the first sub-sealant layer.

17. The manufacturing method as claimed in claim 15, wherein the step of cutting the solid optically clear adhesive into the strip-shaped adhesive block to attach to the lower surface of the first sub-sealant layer further comprises the steps of:
cutting the solid optically clear adhesive into four strip-shaped adhesive blocks;
connecting the four strip-shaped adhesive blocks end to end to form a ring shape; and
attaching the four strip-shaped adhesive blocks to the lower surface of the first sub-sealant layer.

18. The manufacturing method as claimed in claim 15, wherein the step of heating the cover plate assembly and the display panel in the vacuum environment to melt the strip-shaped adhesive block further comprises the steps of:
sending the cover plate assembly and the display panel into a vacuum device;
evacuating the vacuum device by a vacuum pump in a sealed environment; and
heating the cover plate assembly and the display panel by a heating module in the vacuum device to melt the strip-shaped adhesive block.

19. The manufacturing method as claimed in claim 12, wherein a shape of the touch panel is same as a shape of the display panel; and
a size of the touch panel is same as a size of the display panel.
